(19) United States
(12) Patent Application Publication
(10) Pub. No.: US 2004/0126275 A1
(43) Pub. Date: Jul. 1, 2004

(54) Method and device for measuring the lifetime of the fluorescence of fluorophores in samples

(76) Inventors: Klaus Doering, Vigaun (AT); Dieter Popp, Freilassing (DE); Herwig Aistleitner, Salzburg (AT)

Correspondence Address: Womble Carlyle Sandridge & Rice, PLLC, P.O. Box 7037, Atlanta, GA, 30357-0037, US

(21) Appl. No.: 10/622,974

(22) Filed: Jul. 18, 2003

Related U.S. Application Data
(60) Provisional application No. 60/430,266, filed on Dec. 2, 2002.

(30) Foreign Application Priority Data
Jul. 31, 2002 (CH) 2002 1339/02

(51) Int. Cl. G01N 21/64

(52) U.S. Cl. 422/82.08

(57) ABSTRACT

A device (1) and/or a method for measuring the lifetime of the fluorescence of fluorophores in samples are disclosed, the device used (1) including at least one light source (2) for exciting the fluorescence of the fluorophores, an irradiation optic (3) for directing the excitation light (4) onto these samples, a sample table (5) for placing a microplate (6), which contains a sample, at the irradiation optic (3), an emission optic (7) for directing the fluorescence light (8) from the samples onto a detector (9), and at least one detector (9) having analysis electronics. The device disclosed and/or the corresponding method are distinguished in that the irradiation optic (3) of the device (1) includes a beam splitter (10) having at least two mirrors (11), which directs a part of the light (4) from the at least one light source (2), which always enters the beam splitter (10) with the same power and the same pulse shape along a first optical axis (12), in the direction of a sample and allows a part of this light to pass on to the respective mirror (11) lying behind it. In addition, advantageous fiber optics and a computer program, for use in the device disclosed and/or for performing the method disclosed, are disclosed and claimed.

### RELATED APPLICATION DATA

This application claims priority of the Swiss patent application No. 1339/02 filed on Jul. 31, 2002 and of the U.S. provisional application No. 60/430,266 filed on Dec. 2, 2002.

### FIELD OF TECHNOLOGY

The present invention relates to the characterization of samples on the basis of the lifetime of the luminescence emitted by these samples.

### PRI R ART

An essential step toward the development of a pharmaceutically active agent relates to the mass screening of natural and synthetic compounds, which is preferably performed with a high sample throughput. Chemical libraries used for this purpose include hundreds of thousands of different compounds, whose number and complexity is becoming ever larger. In a mass screening, those compounds are preferably selected which have a high affinity to specific receptors and which therefore are promising starting materials for a medication.

This procedure requires solutions, using which the potential candidates (“hits”) may be picked out with greater efficiency. At the same time, however, false hits, which are caused by a high natural fluorescence of the compounds, for example, are to be avoided.

The use of the properties of light to display a test result to determine the activity of a compound in regard to a target molecule or “target” is well known in the field of mass screening (“high throughput screening”=HTS) and also in assay development. The determination of the luminescence intensity or the polarization of the luminescence is extensively described in the related art, particularly for microplate systems (cf., for example, U.S. Pat. No. 6,187,267, WO 99/23466). These systems may be easily integrated into automated facilities, in order to test millions of compounds within a short time. Many of the experimental arrays are based on the determination of the luminescence intensity, either on the basis of spontaneous emission (“fluorescence intensity”=FI), or on the basis of time-delayed emission, which is sometimes referred to as “TRF” (=time resolved fluorescence).

If natural or synthetic compounds are tested, then their natural fluorescence represents a source of interference whose signal is superimposed on the actual fluorescence signal originating from the fluorophores. In the event of high interference signals, this may lead to seriously incorrect interpretations.

The use of metal chelate complexes of rare earths (U.S. Pat. No. 6,242,268) as a marker allows the performance of measurements using time-delayed emission. Such complexes typically have a lifetime of approximately 0.01 to 50 ms, which is significantly longer than the lifetime of the fluorescence of natural substances. In such measurements using time-delayed emission, the fluorescence intensity signal of the metal chelate complexes of rare earths is therefore determined after the interfering fluorescence of the compounds has already decayed. It is to be noted that TRF always means a measurement of the intensity—even if it is time-delayed.

In FI and TRF measurements, the intensity signal is influenced by many factors. These include the “inner filter effect”, scattering due to of the turbidity of the samples, fading of the pigment, and additional volume and meniscus effects. All of these effects are superimposed on the actual signal originating from the fluorophores and may lead to incorrect interpretations of the measurement data arising. In addition, the FI is disadvantageously influenced by the natural fluorescence of the compounds to be investigated.

“FP” (=fluorescence polarization) and “TRET” (=time resolved energy transfer) are also known in microplate measurement systems (cf., for example, U.S. Pat. No. 6,187,267, WO 99/23466). Both methods have been shown to be more robust than FI and TRF. In contrast to FI and TRF, FP and HTRF are based on two measurements, which are calculated via the production of a ratio. In these ratiometric methods, individual artifacts may be avoided. FP and TRET also have their limits: if the generally available, conventional biochemical fluorophores, which have a lifetime in the range of nanoseconds, are used, it is known that FP may be used exclusively for judging biochemical assay systems in which small ligands are bonded to large receptors. FP is also greatly restricted if high-fluorescence compounds have to be tested. TRET always uses 2 labels (cf. European Patent 0 929 810). The selection of the labels or fluorophores is limited in that in each case a donor label and a corresponding acceptor label having spectra which fit with one another must be found. The emission spectrum of the donor (for TRET europium) must overlap with the excitation spectrum of the acceptor.

If the donor and acceptor are very close to one another (typically 5 nm)—for example, through the binding of a molecule labeled with the acceptor to a molecule labeled with the donor—then a non-radiant energy transfer from the donor to the acceptor occurs if the dipole moments of both of them are also aligned optimally to one another. The non-radiant energy transfer causes the acceptor to emit. However, if the donor and acceptor are not near one another, i.e., when no binding has occurred, then only the donor emits. The use of europium allows a time-delayed measurement of the emission. However, for TRET the donor and acceptor emissions must be determined. Problems result if the samples absorb the donor and acceptor fluorescence differently.

Luminescence spectrometers for samples in cuvettes, such as the FL/FS 900 (Edinburgh Instruments Ltd., Riccarton, Currie, Edinburgh, Scotland) allow the characterization of the luminescence properties of a sample, such as the excitation and emission wavelengths, the emission intensity, the polarization, and the life-time of the fluorescence. However, these devices do not fulfill the basic requirements of a routine mass screening. In particular, short processing times and suitability for robots are only provided insufficiently.

Applications of phase modulation technology to determine the fluorescence life-time of samples are described in U.S. Pat. No. 6,317,207. The frequency answer is, however, only simple to interpret for the mono-exponential decay of the fluorescence, while in contrast samples having more than one fluorescence lifetime make a frequency scan necessary. If the sample includes lifetimes which lie widely apart, the frequency scan must cover a wide range: typically 5 MHz up to 5 GHz for lifetimes of 200 ps and 2 ns, respectively, which arise in the same sample. Modulation using frequencies in the GHz range is produced by “cavity dumped” picosecond dye lasers, which are pumped by mode-coupled argon ion lasers. However, this usage is not applicable for automatic testing with high sample throughput (HTS) due to the size and cost of the light sources.

### OBJECTS F THE INVENTION

The object of the present invention is therefore to suggest a device and/or method, using which the fluorescence of samples may be investigated with simple means and high throughput and which is less susceptible to the interfering influences caused by the compounds to be investigated than the devices and methods known from the related art.

This object is achieved by the combination of features of independent claim 1 and/or of independent claim 11.

In this case, the device according to the present invention and/or the method according to the present invention for measuring the lifetime of the fluorescence of fluorophores and samples are defined in a device which has at least one light source for exciting the fluorescence of the fluorophores, an irradiation optic for directing the excitation light onto the samples, a sample table for placement of a microplate containing a sample by the irradiation optic, an emission optic for directing the fluorescence light from the samples onto a detector, and at least one detector having analysis electronics. The device according to the present invention and/or the method according to the present invention are distinguished in that the irradiation optic of the device has a beam splitter having multiple mirrors, which directs a part of the light from the at least one light source, which always enters this beam splitter with the same power and same pulse shape along a first optical axis, in the direction of a sample and allows a part of this light to pass onto the respective mirror lying behind it.

Advantageous refinements and additional features of the present invention result from the dependent claims.

Advantages of the present invention include:

the fluorescence lifetime signal of the sample in the nanosecond range allows—starting from multiple molecules—the assignment and analysis of biochemical test arrays in microplates;

the fluorescence lifetime signal from a time segment measurement may be used to differentiate the actual label signal from the natural fluorescence of the compounds to be investigated;

even in the presence of strongly fluorescent compounds, the label fluorescence may be differentiated easily from the compound fluorescence;

because the fluorescence lifetime signal is exclusively a function of a change of the physical-chemical microenvironment of the sample, artifacts, such as scattering, the “inner filter effect”, and differences in volume and meniscus, do not influence the measurement signal.

### BRIEF DESCRIPTION OF THE DRAWINGS

The present invention is now to be described in more detail on the basis of schematic and exemplary drawings, which are not to restrict the scope of the present invention.

FIG. 1A shows the outline of a device for measuring the lifetime of the fluorescence of fluorophores in samples, according to a first embodiment;

FIG. 1B shows the front view of the device from FIG. 1A;

FIG. 2A shows a three-dimensional illustration of a mirror slide according to the present invention, according to a first embodiment;

FIG. 2B shows a further, three-dimensional illustration of the mirror slide of FIG. 2A;

FIG. 3A shows the outline of a first arrangement according to the present invention of an optical fiber for coupling two lasers at a connection point in front of a collecting lens;

FIG. 3B shows the front view of the arrangement from FIG. 3A, viewed outward from the collecting lens;

FIG. 4 shows a typical time characteristic of the fluorescence intensity measured on an ensemble of fluorophores.

### DESCRIPTION OF THE INVENTION

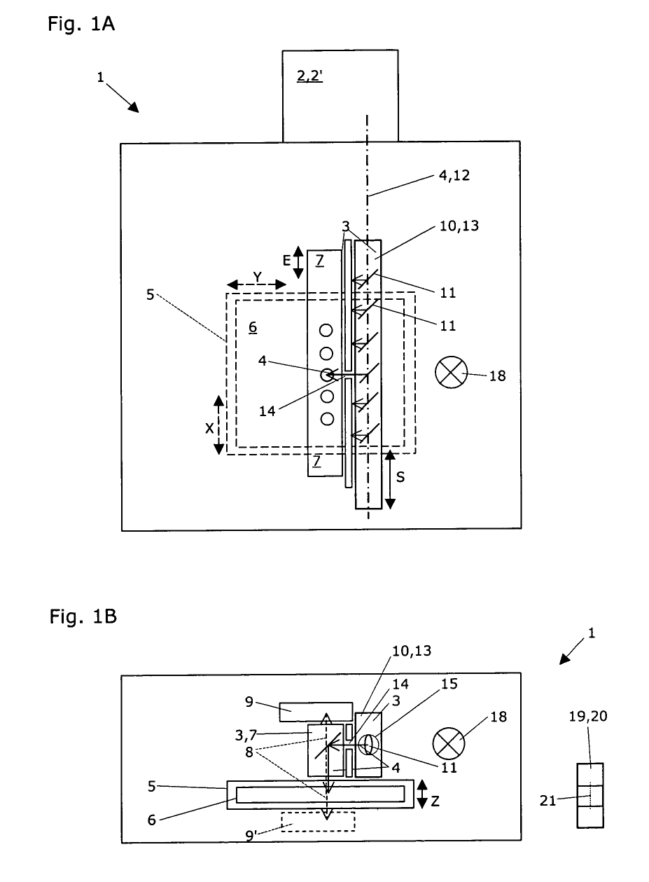

FIG. 1A shows the strongly schematic outline and FIG. 1B shows the corresponding front view of a device for measuring the lifetime of the fluorescence of fluorophores in samples, according to a first embodiment. Device 1 includes at least one light source 2 for exciting the fluorescence of the fluorophores in the samples, an irradiation optic 3 for directing excitation light 4 onto these samples, a sample table 5 for placing a microplate 6 containing the samples at irradiation optic 3, an emission optic 7 for directing fluorescence light 8 from the samples onto a detector 9, and at least one detector 9 having analysis electronics (not shown). Irradiation optic 3 of device 1 includes a beam splitter 10 having multiple mirrors 11, which direct a part of light 4 from at least one light source 2, which always enters this beam splitter 10 with the same power and same pulse shape along a first optical axis 12, in the direction of a sample and allow a part of this light 4 to pass onto respective mirror 11 lying behind it.

The scanning of all wells of a microplate 6 is symbolized by both double arrows X and Y. This movement of sample table 5, which carries a microplate 6, is preferably performed via a computer-controlled automation. The operating distance between irradiation and emission optics 3, 7, respectively, and microplate 6 is preferably also automatically adjustable. In the exemplary embodiment shown here, this operating distance is adjusted by changing the Z-position of sample table 5 (see double arrow Z in FIG. 1B).

Because it must be expected that the samples in a microplate 6, which may include, for example, 96, 384, or even 1536 wells, may fluoresce in different conditions, the intensity of excitation light 4 is to be capable of being varied. The time characteristic of the light impulse may not change in this case. This object is achieved in that a mirror slide 13, according to a first embodiment, is constructed, which has a series of six mirrors 11. All mirrors 11 are mounted at an angle of 45° in relation to a first optical axis 12, along which excitation light 4 comes from light source 2. All mirrors 11 reflect 75% of the incident light intensity by 90° in the direction of a sample. The greatest part of the remaining 25% of the light intensity penetrates each of these mirrors 11 and encounters the surface of respective next mirror 11, lying behind it, which in turn reflects 75%. The use of six mirrors 11 allows the application of six different light intensities while operating only one laser, which always emits excitation light 4 with the same power and same pulse shape. Through the displacement of mirror slide 13 (see double arrow S) and/or of its mirror positions, so that they come to rest exactly opposite one of apertures 14, which lead to the sample and are preferably fixed and unmovable, the selection of six specific intensities for the excitation of the fluorophores of a sample is made possible, without the parameters of laser 2 having to be changed.

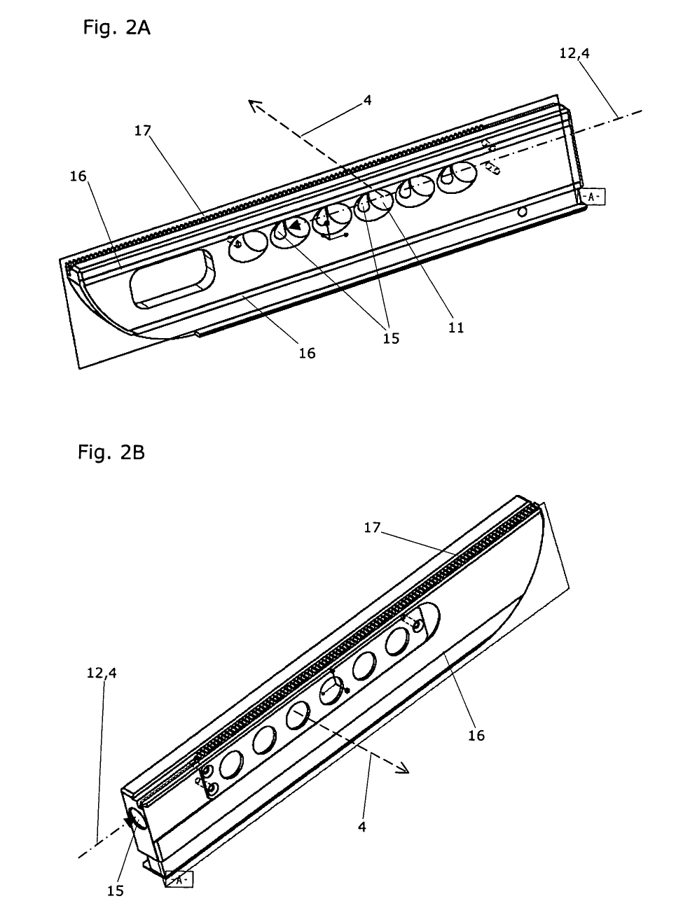

FIGS. 2A and 2B each show a three-dimensional illustration of a mirror slide 13 according to the present invention, according to a first embodiment. This mirror slide 13 includes a hole 15 for the incidence of laser light 4 onto mirror 11 along first optical axis 12. Using raised guide 16 and an inlaid rack 17, in which a pinion of a drive (not shown) engages, the lengthwise displacement of mirror slide 13 along first optical axis 12 is produced.

A further light source 18 in the form of a flashlamp, an LED, and/or a laser, or in the form of a light emitter to be used exclusively continuously, such as a xenon arc lamp, may additionally be used in order to excite the samples to fluorescence. Beam splitter 10 is therefore implemented so it may be removed from device 1 and replaced by a filter element 19. Filter element 19 includes at least one filter 21, which allows a part of the light of further light source 18 to pass in the direction of the sample. If multiple filters 21 are installed, the bandpass of these filters 21 may be identical or different. Preferably, filter element 19 is implemented as a filter slide 20, which is displaceable along first optical axis 12, and is stored outside the device (cf. FIG. 1B). Such a filter slide 20 preferably corresponds in its embodiment, positioning, and mobility to a mirror slide 13, as is illustrated in FIGS. 1 and 2, as much as possible. Therefore, both mirror slide 13 and filter slide 20 are preferably implemented as automatically movable using a drive—including rack 17 and pinion (not shown)—into the correct position for a specific sample.

In order to be able to combine the excitation light from multiple light sources 2 (e.g., from two lasers) of different wavelengths to investigate a sample, this light must be guided to a sample. The diameter of a well of a 1536-well microplate is known to be 1.25 mm. Therefore, the maximum distances between the individual “spots” generated by the different light sources are not to be greater than 1 mm and are preferably even less than 0.5 mm, so that the spots hit a sample with a sufficient distance to the walls of a well.

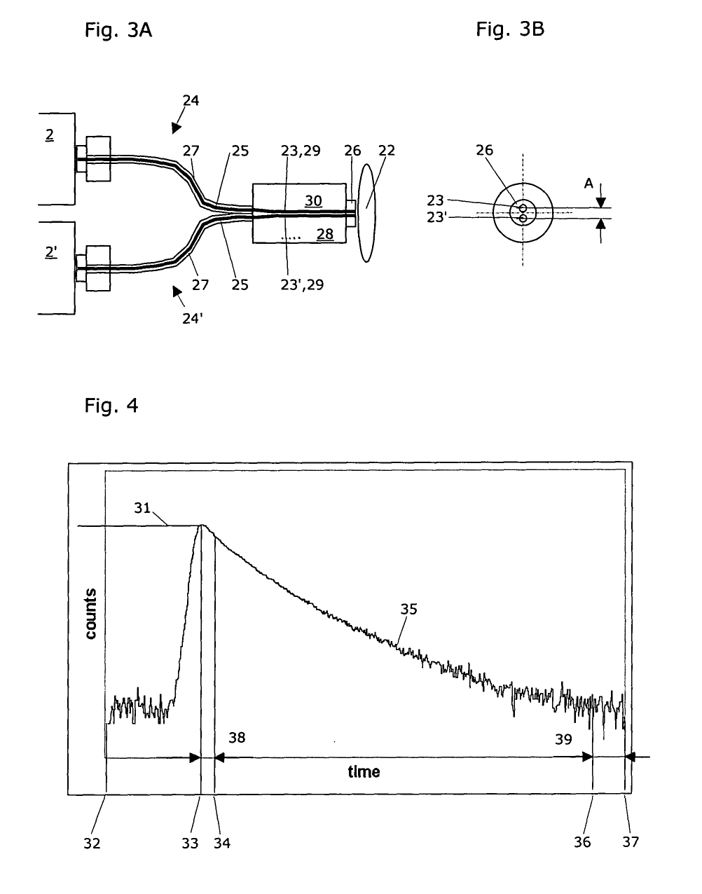

This object was achieved in that (cf. FIG. 3A) the light beam from (in this embodiment) two lasers 2, 2′ is conducted onto the sample via mirrors and lenses of an objective referred to as a connection point 22. Therefore, two overlapping optical paths 23, 23′, which are parallel to one another, are generated for the two colors of the excitation light. Each of the two lasers 2, 2′ feeds its light into one optical fiber 24, 24′ having a diameter of 50 μm. Both light-conducting cores 25, 25′ of both optical fibers 24, 24′ must now be guided into a shared coupling and/or a shared plug 26.

An achievement of the object known from the related art (telecommunications), in which one fiber is somewhat shorter and is welded to the core of the other fiber, is not preferred because a loss of approximately 50% must be expected in the shorter fiber.

Two different embodiments are suggested here:

1) Two fibers 24, 24′ are guided into a shared plug 26, which in turn sits on the objective used as an output coupler. This has the advantage that individual fibers 24, 24′ do not have to be changed physically. It may be considered disadvantageous that both fiber cores 25, 25′ do not come to rest in the center of the lens system. Therefore, both light beams may not be absolutely parallel and overlapping. However, if the deviations are small enough, this achievement of the object represents a favorable and practical compromise. In any case, standard plugs 26 are constructed in such a way that they may hold exactly one fiber, whose sheathing represents a pull relief to protect the fiber. Since two thinner sheathings 27, 27′ must be used here, the stability of these fibers 24, 24′ is somewhat reduced.

2) This solution largely corresponds to solution 1, however with the difference that the pull relief is guided outside plug 26 into a separate housing 28. Both fibers are guided therein, their sheathings are removed, and they are rejoined in a shared sheathing.

In both cases, is advantageous to keep fibers 24, 24′ as short as possible, so that natural fluorescence of the fiber material and/or auto fluorescence may be avoided. Both achievements of the object suggested have the advantage that they are significantly more cost-effective than the best-known use, of a dichroic beam splitter mirror, from the related art. Therefore, the use of three lens systems necessary in the related art—for producing the parallel light in the region of the mirror and for subsequent refocusing of the beam into the sample—may be dispensed with. In addition, if a dichroic beam splitter mirror is used, all three lenses must be perfectly aligned in relation to one another, so that a parallel, overlapping light beam may be produced.

Actually, it is particularly possible using the second embodiment of the fiber joining (cf. FIG. 3), to remove sheathings 27, 27′ of these optical waveguides at connection point 22 in the region of end 29 of first and second optical waveguides 24, 24′ and replace it by a shared sheathing 30, so that optical axes 23, 23′ of both optical waveguides 25, 25′ are at a minimal distance to one another; this distance A is preferably 125 μm (cf. FIG. 3B).

The device preferably contains a detector 9 for the fluorescence techniques, a detector 9′ below the microplate for the absorption, and a further detector 9″ for the luminescence. This detector 9″ (not shown in FIG. 1) is preferably positioned above the microplate and at a distance to detector 9 such that this chemiluminescence detector 9″ may be moved toward any desired well of the microplate through targeted movement of microplate 6 using sample table 5. A device 1 preferably includes a processor for controlling the device and for automatic analysis of the measurement data of detectors 9, 9′, 9″, as well as a drive of sample table 5 for automatic positioning of the wells of the microplate 6 by irradiation optic 3 and emission optic 7 and/or at one of detectors 9, 9′, 9″. The automatic positioning includes at least the positioning of the microplate in a position which is defined by an X value and a Y value of a horizontal, orthogonal coordinate system.

The automatic operation, i.e., irradiation, detection, and analysis in regard to all possible such positions of a microplate, is referred to as a “scan”. Preferably, automatic positioning of the microplate in the Z-direction (perpendicular to the horizontal defined by the X-axis and Y-axis) is also made possible via corresponding motorized drives, so that the operating distance between irradiation optic 3 and emission optic 7 or between detector 9″ and microplate 6 may be optimized automatically.

In addition, a computer program product for controlling the device and for automatic analysis of the measurement data is suggested. This computer program, which may be activated in a computer, is distinguished in that it allows a processor to approach any desired well, a specific number of wells, and/or all wells of the microplate 6 using device 1 described above, to activate the sample in these wells using excitation light 4, to measure the lifetime of the fluorescence emitted by the sample, and to assign the sample a classification number characterizing this lifetime.

The automatic FLT correlation includes the following method steps:

1) Performing a reference measurement without the presence of a sample to determine the device constants.

2) Establishing the boundary conditions for the correlation parameters starting from the reference measurement:

a) Determining time 33 at which maximum 31 occurs;

b) Determining time 36 at which the adjustment ends. This time corresponds to the end of time window 36 minus a constant time interval 39.

3) Measuring the samples in the wells of a microplate and adjusting the sample data:

a) The pre-adjustment is performed biexponentially using the boundary conditions from 2), the results are two lifetimes;

b1) If the first lifetime is short and the first amplitude associated therewith represents a significant proportion of the total amplitude, the adjustment is started beginning from time 33 plus a short time interval 38;

b2) If the conditions of b1) are not fulfilled, the adjustment is started beginning from time 33 plus a long time interval (not shown in FIG. 4);

c1) If the second lifetime is much longer than the first lifetime, a biexponential adjustment is performed, the two lifetimes being determined;

c2) If the conditions of c1) are not fulfilled, a monoexponential adjustment is performed, the single lifetime resulting.

Unfolding is not necessary, since the laser pulses are shorter than the processes to be investigated.

The formula for adjustment is as follows:

$$y = {\sum }_{i = 1}^{n} {α}_{i} * {ⅇ}^{\frac{- t}{{τ}_{i}}} + BG$$

in which:

n=1(2) for mono(bi)-exponential adjustment

t=time distance from zero point

a=amplitude

τ=lifetime

BG=background

y=calculated value which characterizes a sample

FIG. 4 shows a typical time characteristic of fluorescence intensity 35 measured on an ensemble of fluorophore molecules with the aid of time-correlated single photon counting (TCSPC), known per se. Highest measurement point 31, important for automatic adjustment, is illustrated, which marks the maximum of the single photons counted. In addition, the characteristic time marks are 32 (beginning of the measured time), 33 (time of the measurement maximum), 34 (starting point for the correlation of the curve of fluorescence intensity 35), 36 (end point for the correlation of the curve of fluorescence intensity 35), and 37 (end of the measured time).

Any desired combinations of the features of the present invention disclosed are included in its scope.

The reference numbers always refer to identical features, even if all features are not expressly cited for each figure.

What is claimed is:

1. A device (1) for measuring the lifetime of the fluorescence of fluorophores in samples, the device including at least one light source (2) for exciting the fluorescence of the fluorophores, an irradiation optic (3) for directing the excitation light (4) onto these samples, a sample table (5) for placing a microplate (6), which contains samples, at the irradiation optic (3), an emission optic (7) for directing the fluorescence light (8) from the samples onto a detector (9), and at least one detector (9) having analysis electronics,
wherein the irradiation optic (3) of the device (1) includes a beam splitter (10) having at least two mirrors (11), which directs a part of the light (4) from the at least one light source (2), which always enters the beam splitter (10) with the same power and the same pulse shape along a first optical axis (12), in the direction of a sample and allows a part of this light to pass on to the respective mirror (11) lying behind it.

2. The device (1) according to claim 1,
wherein the beam splitter (10) is implemented as a mirror slide (13), movable along this first optical axis (12), and it deflects the light (4) from the first light source (2) by 90° in the direction of a sample.

3. The device (1) according to claim 1,
wherein the mirrors (11) of the beam splitter (10) allow 75% of the incident light (4) to reflect and 25% of this light to pass onto the respective mirror (11) lying behind it.

4. The device (1) according to claim 1, which also includes a further light source (18),
wherein the beam splitter (10) is implemented so it may be removed from the device (1) and replaced by a filter element (19), the filter element (19) including at least one filter (21), which allows a part of the light of the light source (18) to pass in the direction of the sample.

5. The device (1) according to claim 4,
wherein the filter element (19) is implemented as a filter slide (20), movable along this first optical axis (12), the bandpass of the filters (21) being identical or different.

6. The device (1) according to claim 2,
wherein the mirror slide (13) or filter slide (20) is implemented so it may be automatically moved, using a drive, into the correct position for a specific sample.

7. The device (1) according claim 1, the device (1) including two light sources (2) in the form of lasers,
wherein the two lasers are coupled to a first optical waveguide (25) and/or second optical waveguide (25′) and the two optical waveguides (25, 25′) feed the light of the two lasers to a connection point in a collecting lens (22), using which the two focal points thus defined may be positioned in a specific well of a microplate (6).

8. The device (1) according to claim 7,
in which, at the connection point (22) in the region of the end (29) of the first and second optical waveguides (25, 25′), the sheathing (27, 27′) of these optical waveguides is removed and replaced by a shared sheathing (30), so that the optical axes (23, 23′) of the two optical waveguides (25, 25′) lie at a minimum distance (A) to one another.

9. The device (1) according to claim 8,
wherein the minimum distance (A) is 125 μm.

10. The device according to claim 1,
wherein the device includes a processor for controlling the device (1) and for automatic analysis of the measurement data of the detectors (9, 9′, 9″) and a drive of the sample table (5) for automatic positioning of the wells of a microplate (6) at the irradiation optic (3) and emission optic (7).

11. A method of measuring the lifetime of the fluorescence of fluorophores in samples in a device (1), the device including at least one light source (2) for exciting the fluorescence of the fluorophores, an irradiation optic (3) for directing the excitation light (4) onto these samples, a sample table (5) for placing a microplate (6), which contains a sample, at the irradiation optic (3), an emission optic (7) for directing the fluorescence light (8) from the samples onto a detector (9), and at least one detector (9) having analysis electronics,
wherein the light from the at least one light source (2) is always fed with the same power and the same pulse shape along a first optical axis (12) into the beam splitter (10), the beam splitter (10) including at least two mirrors (11), using which a part of the light (4) from the at least one light source (2) is deflected in the direction of a sample and a part of this light (4) is passed through to the respective mirror (11) lying behind it.

12. The method according to claim 11,
wherein the beam splitter (10) is implemented as a mirror slide (13) movable along this first optical axis (12), the mirrors (11) of the beam splitter (10) each allowing 75% of the incident light to reflect by 90° in the direction of a sample and 25% of this light to pass onto the respective mirror (11) lying behind it.

13. The method according to claim 11, in which a device (1) is used which also includes a further light source (18),
wherein the beam splitter (10) is removed from the device (1) and replaced by a filter element (19), the filter element (19) being implemented as a filter slide (20), movable along this first optical axis (12), having one or more filters (21)—which allow a part of the light of the further light source (18) to pass in the direction of the sample.

14. The method according to claim 12,
wherein the mirror slide (13) and/or the filter slide (20) is/are automatically moved using a drive into the correct position for a specific sample.

15. The method according to claim 11, a device (1) being used which includes two light sources (2) in the form of lasers,
wherein the two lasers are coupled to a first optical waveguide (25) and second optical waveguide (25′), respectively, and the two optical waveguides (25, 25′) feed the light of the two lasers to a connection point in a collecting lens (22), which positions the two focal points thus defined in a specific well of a microplate (6).

16. The method according to claim 11,
which has the following operating steps:
1) Performance of a reference measurement without the presence of a sample to determine the device constants.
2) Establishing the boundary conditions for the correlation parameters starting from the reference measurement:
a) Determining time (33) at which maximum (31) occurs;
b) Determining time (36) at which the adjustment ends, a constant time interval (39) being subtracted of the end of time window (36);
3) Measuring the samples in the wells of a microplate.

17. The method according to claim 16,
in which, during measurement of the samples in the wells of a microplate (6), an adjustment of the sample data is performed which includes the following steps:
a) Biexponential pre-adjustment using the boundary conditions from 2), the results are two lifetimes;
b1) If the first lifetime is short and the first amplitude associated therewith represents a significant proportion of the total amplitude, the adjustment is started beginning from time (33) plus a short time interval (38);
b2) If the conditions of b1) are not fulfilled, the adjustment is started beginning from time (33) plus a long time interval;
c1) If the second lifetime is much longer than the first lifetime, a biexponential adjustment is performed, the two lifetimes being determined;
c2) If the conditions of c1) are not fulfilled, a monoexponential adjustment is performed, the single lifetime resulting.

18. A computer program product for controlling the device (1) and for automatic analysis of the measurement data,
wherein a computer program activated in a computer allows a processor, using the device (1)—according to at least one of claims 1 to 10—to approach at least one well of a microplate (6), to activate the probe in the well using excitation light (4), to measure the lifetime of the fluorescence (8) emitted by the sample, and to assign the sample a classification number which characterizes this lifetime.

19. A computer program product for controlling the device (1) and for automatic analysis of the measurement data,
wherein a computer program activated in a computer allows a processor, using the method according to at least one of claims 11 to 17, to approach at least one well of a microplate (6), to activate the probe in the well using excitation light (4), to measure the lifetime of the fluorescence (8) emitted by the sample, and to assign the sample a classification number which characterizes this lifetime.
